(19) United States
(12) Patent Application Publication
(10) Pub. No.: US 2004/0057690 A1
(43) Pub. Date: Mar. 25, 2004

(54) Optics-integrated structure comprising in a substrate at least a non-buried guide portion and method for making same

(76) Inventors: Gilles Clauss, Voreppe (FR); Serge Valette, Grenoble (FR)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/470,708

(22) PCT Filed: Jan. 29, 2002
(86) PCT No.: PCT/FR02/00343

(30) Foreign Application Priority Data
Jan. 31, 2001 (FR) 01/01300

(51) Int. Cl. G02B 6/10

(52) U.S. Cl. 385/129

(57) ABSTRACT

Integrated optical structure containing, in a substrate, an optical guide having at least one non-buried guide portion and on the surface of the substrate at least one coating element (5) located above the non-buried guide portion and able to isolate within said guide portion a light wave propagating therein.

Application to integrated optical components such as optic amplifiers, optic multiplexors, optic splitters, optic couplers . . . .

### TECHNICAL FIELD

The present invention concerns an integrated optical structure containing at least one non-buried guide portion in a substrate, and its process of fabrication.

It applies to numerous components in integrated optics such as in particular optic amplifiers, optic multiplexors, optic splitters, optic couplers . . . and, in general, to any component using at least one portion of non-buried optical guide.

### PRIOR ART

An optical guide is made up of a central part generally called the core and surrounding media positioned around the core which may be identical or different from one another.

To enable light confinement inside the core, the refractive index of the medium forming the core must be different from and in most cases greater than those of the surrounding media.

To simplify the description, the guide will be considered as its central part. Also all or part of the surrounding media will be denoted as the substrate, it being understood that if the guide is little or not buried one of the surrounding media may be located outside the substrate possibly being air for example.

Depending upon the type of technique used, the substrate may be single or multilayer.

In addition, depending upon applications, an optical guide in a substrate may be buried to a greater or lesser extent in this substrate, and in particular may comprise guide portions buried at varying depths.

Therefore, for example, in some applications the optical guides of an integrated optical structure made in a substrate using ion exchange technology in particular, must have structure input and output connections. On this account, the light propagation mode of the waveguides, at least for input and output, must be close to that of the fibre to be associated with it. Yet this propagation mode is often relatively little confined.

With low confinement it is not possible to produce bent optical guides having curve radii typically less than 20 mm, which may be penalising in respect of component size.

To obtain low curve radii, the lateral confinement of the guides must therefore be increased.

To reconcile these constraints, guides are known which have:

firstly, low confinement guide portions at least for input and output; the width of these portions is adapted to that of the fibres and these portions are therefore buried using ion exchange guide fabrication technology,

secondly, strong confinement guide portions adapted for low curve radius which, in this technology, are therefore in the vicinity of the substrate surface.

Guides positioned in the vicinity of the surface are ill-protected from the environment and have optical losses which may be high and may increase in time on account of pollution on the substrate surface.

Also, the use of a protection layer on the substrate to protect the structure from the environment would lead to mechanical stresses on the substrate (in particular on account of problems related to different coefficients of thermal expansion) and would impair its operating function. These constraints could in particular cause birefringence effects that are detrimental in some applications.

### DISCLOSURE OF THE INVENTION AND SHORT DESCRIPTION OF THE FIGURES

The invention concerns an integrated optical structure containing, in a substrate, at least one non-buried guide portion isolated from the environment by means inducing little or no mechanical stresses on the structure.

In the present invention, by “non-buried” is meant a guide located in the vicinity of the substrate surface, i.e. the thickness of the material separating the core from the surface substrate is null or insufficient to prevent avoid optical losses, through evanescent wave for example associated with a propagation mode of the light wave in the guide.

More precisely, the subject of the invention is an integrated optical structure containing, in a substrate, an optical guide having at least one portion of non-buried guide; it is characterized in that it also comprises at least one coating element on the substrate surface located above the non-buried guide portion able to isolate in said guide portion a light wave propagating therein.

The structure of the invention comprises several non-buried guide portions, each portion being associated with a coating element.

The use of coating elements, at least on the non-buried guide portion, makes it possible to isolate these portions from the outside and to prevent optical losses.

With these coating elements it is therefore possible to produce structures with guides having strong confinement, since this type of guide cannot be buried, and it is therefore possible to have bent guides in particular having a low bend radius.

In addition, by limiting coating to elements arranged on the non-buried guide portions, it is possible to minimise the onset of interference such as mechanical stresses which could impair the operating function of the structure.

According to one embodiment, the guide comprises at least one non-buried guide portion and at least one buried guide potion, the coating element being located over the buried and non-buried guide portions. In this embodiment too, coating is limited since it does not cover the entirety of the substrate.

The coating element has a thickness Wp at least equal to the minimum thickness Wm that is required to prevent an evanescent wave associated with the light wave guided into said portion from leaving the structure.

The coating element is single or multilayer; the refractive index or indices are such that an evanescent wave associated with the light wave guided into said portion is unable to leave the structure. More precisely, the refractive indices are respectively lower than the smallest effective index of the propagation modes able to be guided into said non-buried portion, and preferably lower than the maximum refractive index of the substrate.

The coating element is chosen for example from among silica or a glass of appropriate index.

The coating element has a width Lp such that an evanescent wave associated with the light wave guided into said portion is unable to leave the structure. More precisely, it is equal to or greater than the width of the widest propagation mode able to propagate in said non-buried guide portion.

Width Lp can be either constant or variable. In particular, if coating elements cover both buried and non-buried portions of the guide, then the width of these elements may be similar to the width of the guided modes in the corresponding guide portions, or they may be greater than the width of the mode in the least confined guide.

A further subject of the invention is a process for fabricating an integrated optical structure containing, in a substrate, an optical guide having at least one non-buried guide portion and on the substrate surface at least one coating element above the non-buried guide portion; this process comprising the following steps:

A) forming in a substrate at least one waveguide with at least one non-buried guide portion,

B) forming the coating element above the non-buried portion

Step B) comprises depositing a coating layer on the substrate, then forming a mask on this layer to protect the guide portion(s) to be coated, etching the coating layer through the mask so as to obtain the coating element or elements.

The mask is generally removed but can evidently be maintained in some cases.

According to one embodiment, the coating layer is deposited by cathode sputtering or vacuum evaporation.

According to one example of embodiment, step A) comprises the formation of a waveguide in a glass substrate by ion exchange, localised back scattering of this guide so as to bury at least one portion of the guide, the non-buried guide portion having stronger confinement than the buried portion.

This back scattering can conventionally be obtained by metal masking and application of an electric field either side of the portion to be buried.

This back scattering in the substrate is made in such manner as to ensure the desired operating function of the component in the portion(s) under consideration. For example it is used to optimise coupling with input and/or output optic fibres.

The characteristics and advantages of the invention will become better apparent on reading the following description. This description concerns examples of embodiment given for explanatory purposes which are non-restrictive. It refers to the appended drawings in which:

FIGS. 1a, 1b, 1c schematically show different steps in one embodiment of a structure of the invention,

FIG. 2 is a perspective diagram of a first variant of the structure of the invention,

FIG. 3 is a perspective diagram of a second variant of the structure of the invention.

### DETAILED DESCRIPTION OF EMBODIMENTS

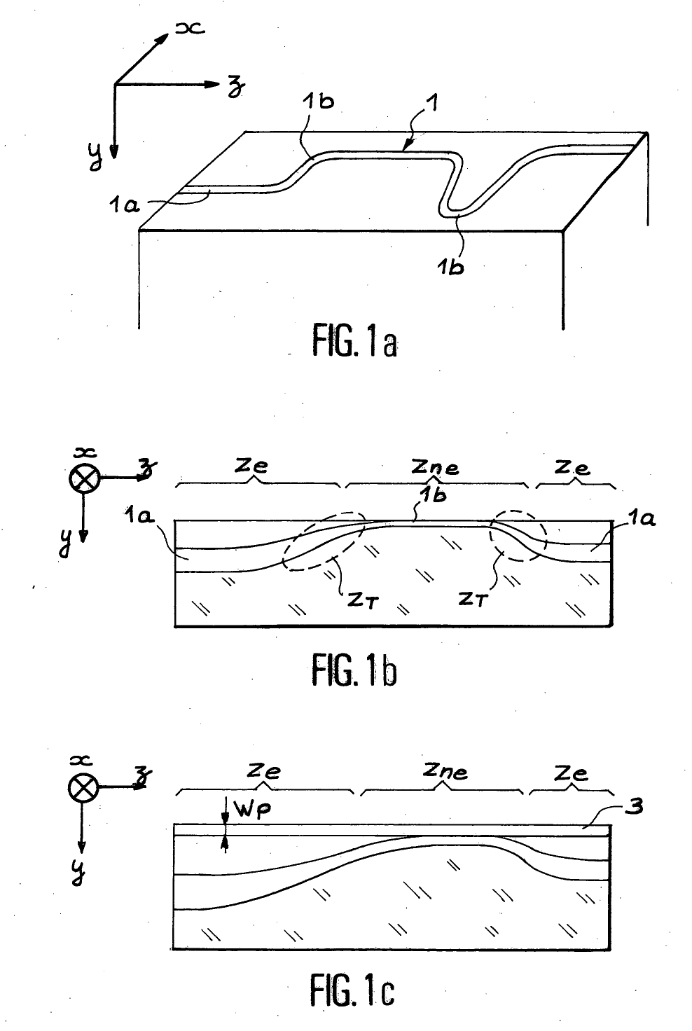

FIG. 1a schematically shows a first step in the fabrication of an integrated optical structure of the invention.

In a substrate, in glass for example, through a mask (not shown) a waveguide is made using the known technique of ion exchange. Waveguide 1 shown in this figure is not buried, it is parallel to the plane defined by the substrate surface and comprises straight parts 1a and bent parts 1b.

To allow fabrication of a guide with low curve radius, and in particular to obtain compact components, this non-buried waveguide preferably has strong confinement.

After fabricating this guide, the process of the invention consists of locally scattering portions of the guide under an electric field to bury these portions.

One example of partial burying of a guide is illustrated in particular in patent U.S. Pat. No. 5,708,750.

FIG. 1b shows the structure after this operation. The mask (not shown) used to obtain this scattering is preferably removed when the operation is completed. It may however be removed subsequently in some cases or even maintained above the guides to form part of the coating elements.

In FIG. 1b therefore, zones Ze of the structure can be seen comprising straight guide portions 1a which are buried in the substrate and a zone Zne of the structure comprising the non-buried guide portion, this portion containing bent guides 1b.

Between the buried and non-buried guide portions there are transition zones Zt; that part of these zones in which the thickness of the material separating the guide core from the substrate surface is either null or insufficient to prevent optical losses, is considered as forming part of the non-buried guide portion; and that part of these zones in which said thickness is sufficient to prevent optical losses is considered as being buried.

In this example of embodiment only one non-buried guide portion is shown, but evidently it is possible to have a guide with several non-buried portions, for example respectively separating two bent guide parts.

FIG. 1c illustrates the fabrication of a coating layer 3 on the structure.

This layer is single or multilayer and is in silica for example or glass with a refractive index adapted, as seen above, so that an evanescent wave associated with the light wave guided into said portion is unable to leave the structure; this layer is deposited by cathode sputtering or vacuum evaporation.

Also thickness Wp of this layer is chosen so that the evanescent wave associated with the mode guided into the non-buried portion is unable to see the medium located above the layer.

In general this thickness typically lies between 0.3 and 5 μm.

After forming the coating layer, the coating element or elements are then made. Several techniques can be considered.

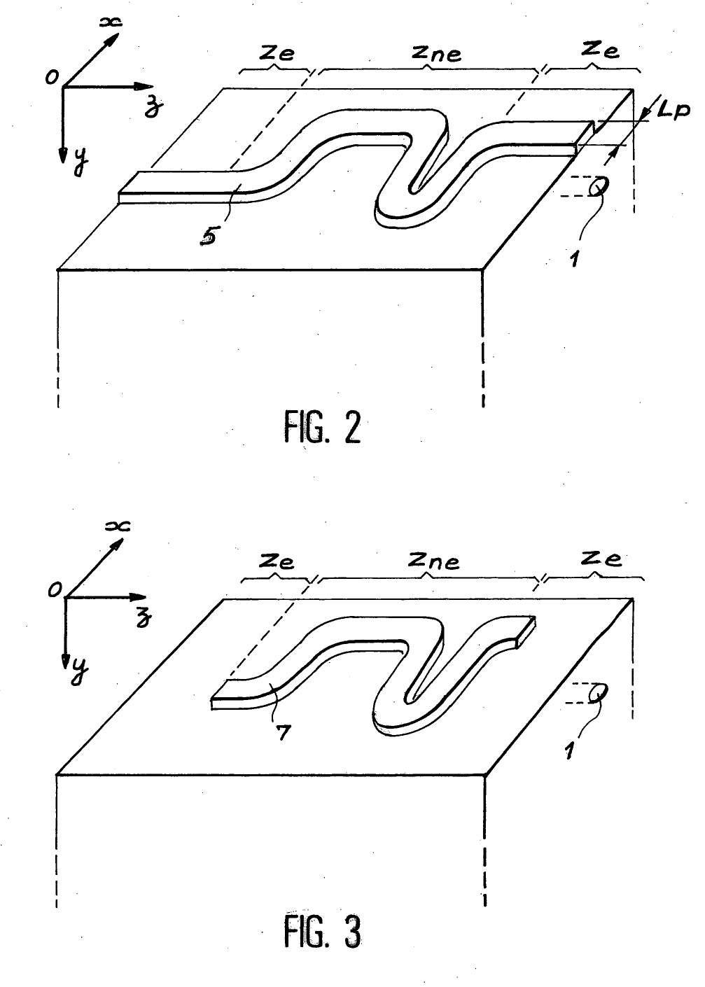

According to a first mode shown in FIG. 2, the coating layer 3 is etched so that only one coating element 5 subsists located above the guide assembly both in its non-buried and in its buried portion. Width Lp of the coating element must be the same or greater than a determined minimum width so that the evanescent wave associated with the mode guided into the non-buried portion of the structure is unable to see the medium located above said element. This width may be constant, as shown, or variable.

According to a second embodiment shown in FIG. 3, coating layer 3 is etched so that only one coating element 7 subsists located solely over the non-buried guide portion.

The characteristics of this element are the same as for the element in FIG. 2.

To etch the coating element both in the example in FIG. 2 and in the example of FIG. 3, a resin mask for example is made on the coating layer, the mask being isolated and developed using conventional microelectronics techniques so as to obtain a pattern corresponding to the coating element it is desired to obtain. Then the coating layer is etched through this mask, for example by ion etching or chemical etching for a layer in silica. The mask is then generally removed unless it does not hinder the structure.

According to a further embodiment, if the guide of the structure is entirely non-buried, then the coating element is of the type shown in FIG. 2, i.e. it is above the guide and follows the same pathway.

1. Integrated optical structure containing, in a substrate, an optical guide (1) having at least one non-buried guide portion (1b), characterized in that it also comprises on the substrate surface at least one coating element (5, 7) positioned above the non-buried guide portion and able to isolate within said guide portion a light wave propagating therein.

2. Structure according to claim 1, characterized in that the guide comprises several non-buried guide portions, each portion being associated with a coating element.

3. Structure according to either of claims 1 and 2, characterized in that the guide comprises at least one non-buried guide portion (1b) and at least one buried guide portion (1a), the coating element being located above the buried and non-buried guide portions.

4. Structure according to any of claims 1 to 3, characterized in that the coating element has a thickness Wp at least equal to the minimum thickness Wm required so that an evanescent wave associated with the light wave guided into said non-buried guide portion is unable to leave the structure.

5. Structure according to any of claims 1 to 4, characterized in that the coating element is single or multilayer and the refractive index or indices are respectively lower than the smallest effective indices of the propagation modes able to be guided into said non-buried portion.

6. Structure according to claim 5, characterized in that the refractive index of the coating element is lower than the maximum refractive index of the substrate.

7. Structure according to any of claims 1 to 6, characterized in that the coating element has a width Lp equal to or more than the width of the widest propagation mode able to propagate in said non-buried guide portion.

8. Structure according to any of claims 1 to 7, characterized in that the coating element is chosen from among silica, glass of appropriate index.

9. Process for fabricating an integrated optical structure containing, in a substrate, an optical guide (1) having at least one non-buried guide portion (1b) and on the substrate surface at least one coating element (5, 7) above the non-buried guide portion, this process comprising the following steps:
A) in a substrate making at least one waveguide having at least one non-buried guide portion,
B) forming a coating element over the non-buried portion.

10. Process according to claim 9, characterized in that step B) comprises the depositing on the substrate of a coating layer (3) then forming on this layer a mask protecting the portion(s) of guide to be coated, etching the coating layer through the mask to obtain the coating element or elements.

11. Process according to either of claims 9 and 10, characterized in that the coating layer is deposited by cathode sputtering or vacuum evaporation.

12. Process according to any of claims 9 and 11, characterized in that step A) comprises forming a waveguide in a glass substrate by ion exchange, and localised back scattering of this guide so as to bury at least one guide portion.
